(19) United States
(12) Patent Application Publication
(10) Pub. No.: US 2005/0008039 A1
(43) Pub. Date: Jan. 13, 2005

(54) Digital-broadcast receiving apparatus and method

(76) Inventors: Koichi Funaya, Tokyo (JP); Takato Matsumura, Tokyo (JP)

Correspondence Address: Michael J. Scheer;DICKSTEIN SHAPIRO MORIN & OSHINSKY LLP, 41st Floor, 1177 Avenue of the Americas, New York, NY, 10036-2714, US

(21) Appl. No.: 10/913,362

(22) Filed: Aug. 9, 2004

Related U.S. Application Data
(62) Division of application No. 09/476,900, filed on Jan. 3, 2000.

(30) Foreign Application Priority Data
Jan. 8, 1999 (JP) 2966/1999

(51) Int. Cl. H04J 3/02; H04J 3/24

(52) U.S. Cl. 370/474

(57) ABSTRACT

Digital carrying streams are demodulated by a plurality of demodulating circuits and outputs of the demodulating circuits are input to a program filter. The program filter extracts only the data necessary for recording and reproducing from a plurality of input carrying streams and outputs the data to a memory buffer. The data supplied to a recording/reproducing circuit via the memory buffer is recorded in a recording medium in accordance with a designation of a user or directly transferred to a decoder. The data recorded in the recording medium is transferred to the decoder via the recording/reproducing circuit in accordance with a designation of the user.

### CROSS-REFERENCE TO RELATED APPLICATIONS

The present application is a divisional under 37 C.F.R. §1.53(b) of prior application Ser. No. 09/476,900, filed Jan. 3, 2000, by Koichi Funaya et al. and, entitled Digital-Broadcast Receiving Apparatus and Method.

### BACKGROUND OF THE INVENTION

1. Field of the Invention

The present invention relates to a digital-broadcast receiving apparatus and method, particularly to digital-broadcast receiving apparatus and method for demodulating and filtering a plurality of programs data.

2. Description of the Related Art

A program filter used for a conventional digital-broadcast receiving apparatus filters a single carrying stream input from one demodulating circuit and transfers a filtered result to an image-and-sound decoder to reproduce sounds and images. For example, the format of a transport stream in the standard ISO/IEC 13818-1 (MPEG-2) decided by ISO (International Organization for Standardization) is known as the format of a single carrying stream. In case of the transport stream, a plurality of programs are included in one stream and moreover, programming for telecast and an extension function such as a scramble function are included.

Moreover, in case of a conventional program filter, when data to be output occurs as a result of filtering, output of the data is requested for an outside user to interrupt the program of the outside user.

Furthermore, to filter a plurality of carrying streams by using a conventional program filter, carrying streams output from different demodulating circuits are filtered by different program filters. Then, each program filter has its own memory buffer and stores a filtered result in each memory buffer.

Furthermore, a conventional program filter does not transfer any filtered result to another unit again through a network.

Furthermore, a conventional program filter outputs a new packet or a payload included in the packet whenever the packet arrives regardless of whether the information carried by a packet included in each carrying stream is table-type information, combined-table-type information, or stream-type information.

The above conventional program filters have the problems described below.

A first problem is that, because a conventional program filter is configured by so as to filter a single carrying stream input from one demodulating circuit, it is not suitable for the case in which a plurality of programs are simultaneously filtered and spooled in parallel.

A second problem is that, because a conventional program filter is configured so as to request an outside user to output data from the program filter side and wait for a permit when filtered-result data is ready for output, it is necessary for a user-side program to interrupt other processing and transfer requested data.

A third problem is that, to filter a plurality of carrying streams by using a conventional program filter, each program filter has its own memory buffer and therefore, a memory working efficiency lowers or a memory capacity increases.

A fourth problem is that it is impossible for a conventional program filter to packet-divide a filtered result again and transfer packet-divided filtered results to another unit via a network.

A fifth problem is that, because a conventional program filter is configured so as to output a packet ID recorded in the packet of each carrying stream when the packet ID matches a designated packet ID, it is necessary to decode a plurality of carrying streams and search a related packet ID whenever a packet ID cannot be directly detected.

A sixth problem is that, because a conventional program filter buffers filtered information on a memory independently of whether the filtered information is table-type information, combined-table-type information, or stream-type information, table-type data is redundantly and repeatedly written in the memory and resultantly the memory consumption increases.

A seventh problem is that it is necessary for a user to change settings of a demodulating circuit in a conventional program, when the information designated by the user is not present in a carrying stream.

An eighth problem is that, because a plurality of conventional program filters respectively correspond to demodulating circuits one to one, it is impossible to make the setting of a certain program filtersuitable for a carrying stream sent from another demodulating circuit which does not originally correspond to the setting.

### SUMMARY OF THE INVENTION

### OBJECT OF THE INVENTION

It is an object of the present invention to provide a program filter making it possible to simultaneously filter a plurality of carrying streams in parallel.

### SUMMARY OF THE INVENTION

To attain the above object, the present invention temporarily stores results of filtering a plurality of carrying streams in a buffer memory and transfers filtered results from the buffer memory to a user-side unit, when any transferring request from the user-side unit is received.

In FIGS. 1 and 2, a program filter of the present invention is provided with a packet filter 11 for receiving an input from each demodulating circuit (2) and extracting only the necessary information designated by a user therefrom and a memory interface 12 for writing an output of the packet filter 11 in a memory buffer 3. The packet filter 11 judges whether the packet ID of each packet in a carrying stream serving as an output of a demodulating circuit coincides with a previously entered packet ID and passes the packet when the former packet ID coincides with the latter packet ID. The memory interface 12 writes a packet passing through the packet filter 11 in the memory buffer 3. A user reads a filtered result by accessing the memory buffer 3.

That is, when a plurality of carrying streams are filtered by a single program filter, filtered results are temporarily stored in a memory buffer and the results are transferred in accordance with a request from a user. Thus, it is possible to handle requests from a plurality of users or from processes or threads on a plurality of host processors by distinguishing between them. Moreover, it is possible to output a filtered result in accordance with the condition of a user-side program and it is unnecessary to other program of the user side.

In the case of the present invention, because a buffer memory is configured by a single memory space, the frequency for assigning an excessive memory area to each carrying stream is decreased and it is possible to improve the working efficiency of a memory and reduce the capacity of the memory.

The present invention makes it possible to access one buffer memory by storing filtered results in a buffer memory through time-sharing.

The present invention makes it possible to packet-divide the data obtained as a result of filtering again by temporarily storing the header information of each packet passing through a filter and thereafter reusing the information. Thereby, it is possible to transfer a filtered result via a network.

The present invention makes it possible to reduce a memory capacity required to store table-type information by distinguishing between table-type information and stream-type information and always overwriting the table-type information with newly arriving information.

The present invention stores combined-table-type information in a memory buffer by separating it from table-type information or stream-type information. Thus, it is possible to reduce a necessary memory capacity compared to a case of storing combined-table-type information as stream-type information. Moreover, by separately retrieving one piece or a plurality of pieces of table-type information configuring combined-table-type information, it is possible to reduce the amount of data to be transferred to an outside user and improve the convenience.

The present invention automatically filters and stores related program information by keeping and controlling a program-information table in a program filter. By using filtered program information, it is possible to update the program-information table and thereby, a program-information table according to the latest information is always generated.

The present invention makes it possible to convert a program ID designated by a user into a packet ID by referring to a program-information table and filter a carrying packet by using the packet ID obtained as a result of conversion.

The present invention makes it possible to judge in a program filter whether the information requested by a user can be obtained from a carrying stream by referring to a program-information table. Moreover, by referring to the program-information table, it is possible for a program filter to automatically change settings of a demodulating circuit and possible to output the carrying stream necessary for the demodulating circuit.

The present invention makes it possible to apply a certain filtering condition to an optional carrying stream by making it possible to set respective filtering conditions independently of the carrying stream. Thereby, it is possible to apply a filtering condition once set a carrying-stream output of a demodulating circuit not used at that point of time and reduce the throughput for setting filtering conditions.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 is an illustration showing an embodiment of a digital-broadcast receiving apparatus mounting a program filter of the present invention;

FIG. 2 is a block diagram showing a first embodiment of a program filter of the present invention;

FIG. 3 is an illustration showing a plurality of carrying streams output from a plurality of demodulating circuits;

FIG. 4 is an illustration showing an internal configuration of a packet configuring a carrying stream;

FIG. 5 is an illustration showing a configuration of the header of the packet in FIG. 4;

FIG. 6 is a flow chart showing the processing procedure of the packet filter of the first embodiment of the present invention shown in FIG. 2;

FIG. 7 is a block diagram showing the hardware configuration of the packet filter of the first embodiment of the present invention shown in FIG. 2;

FIG. 8 is a block diagram showing a configuration of a memory interface of the first embodiment of the present invention;

FIG. 9 is an illustration showing a configuration of the memory buffer in FIG. 8;

FIG. 10 is an illustration showing another configuration of the memory buffer in FIG. 8;

FIG. 11 is a block diagram showing the configuration of a program filter of a second embodiment of the present invention;

FIG. 12 is a block diagram showing the configuration of a program filter of a third embodiment of the present invention;

FIG. 13 is a block diagram showing the configuration of a program filter of a fourth embodiment of the present invention;

FIG. 14 is a block diagram showing the configuration of a program filter of a fifth embodiment of the present invention;

FIG. 15 is a block diagram showing the configuration of a program filter of a sixth embodiment of the present invention;

FIG. 16 is a block diagram showing the configuration of a program filter of a seventh embodiment of the present invention;

FIG. 17 is a block diagram showing the configuration of a program filter of an eighth embodiment of the present invention;

FIG. 18 is a block diagram showing the configuration of a program filter of a ninth embodiment of the present invention; and

FIG. 19 is an illustration showing a configuration of a filter-setting-parameter storing memory of a tenth embodiment of the present invention.

### DESCRIPTION OF THE PREFERRED EMBODIMENTS

Embodiments of the present invention will be described below by referring to the accompanying drawings.

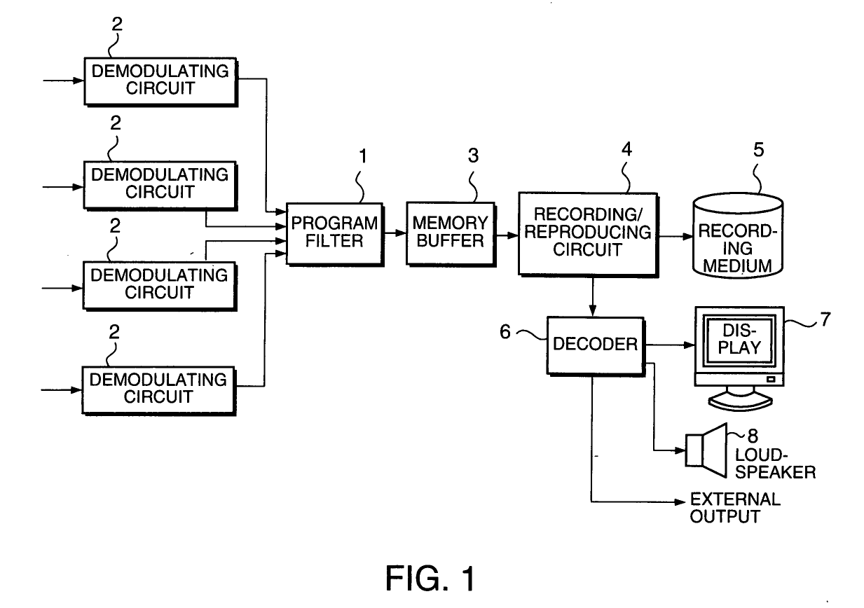

FIG. 1 is an illustration showing a configuration of a digital-broadcast receiving apparatus of the present invention. Referring to FIG. 1, digital carrying streams are demodulated by a plurality of demodulating circuits 2 and outputs of the demodulating circuits 2 are input to a program filter 1. The program filter 1 extracts only the data to be recorded and reproduced out of a plurality of input carrying streams and outputs the data to the memory buffer 3. The data supplied to a recording/reproducing circuit 4 via the memory buffer 3 is recorded in a recording medium 5 in accordance with a designation of a user and directly transferred to a decoder 6. The data recorded in the recording medium 5 is transferred to the decoder 6 via the recording/reproducing circuit 4 in accordance with a designation of a user.

The data transferred to the decoder 6 is converted into a format usable by the user or a format which can be obtained by the user in audiovisualable manner through a display 7 and a loudspeaker 8 and an output of the decoder 6 is provided for the user through the display 7 and loudspeaker 8.

This embodiment makes it possible to provide the information obtained via a plurality of demodulating circuits 2 for a plurality of audiences (users) via a plurality of displays.

The apparatus shown in FIG. 1 is configured so as to temporarily record data in the recording medium 5. Moreover, it is possible to provide the information obtained via a plurality of demodulating circuits 2 in a device without any recording medium 5 for a plurality of audiences (users).

It is also permitted to use a configuration provided with either of the display 7 and loudspeaker 8 or use an optional unit capable of providing information for a user in the form of a format desired by the user as an output unit.

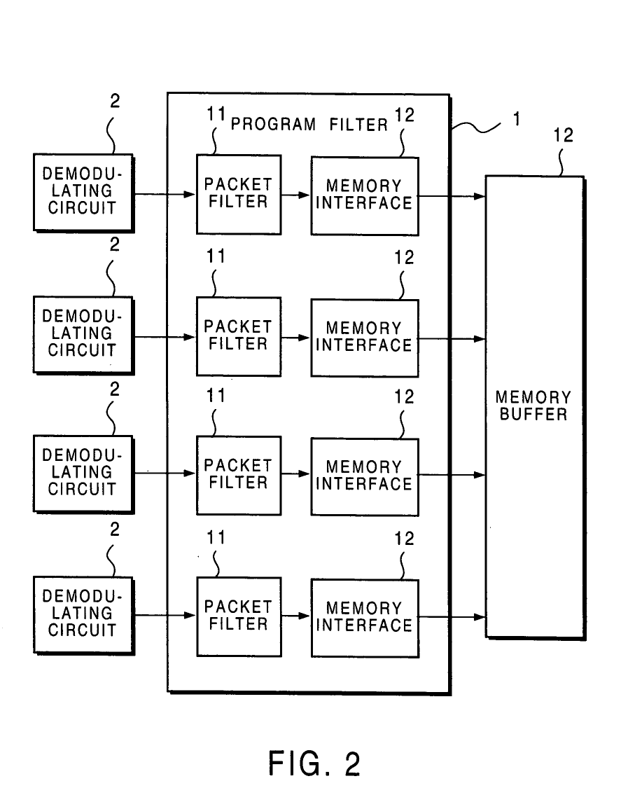

FIG. 2 is an illustration showing the configuration of the first embodiment of the program filter 1. In FIG. 2, the program filter 1 is provided with a plurality of packet filters 11 for using outputs of a plurality of demodulating circuits 2 as inputs and extracting only the necessary information according to a designation of a user from the inputs and a plurality of memory interfaces 12 for writing outputs of a plurality of packet filters 11 in the memory buffer 3.

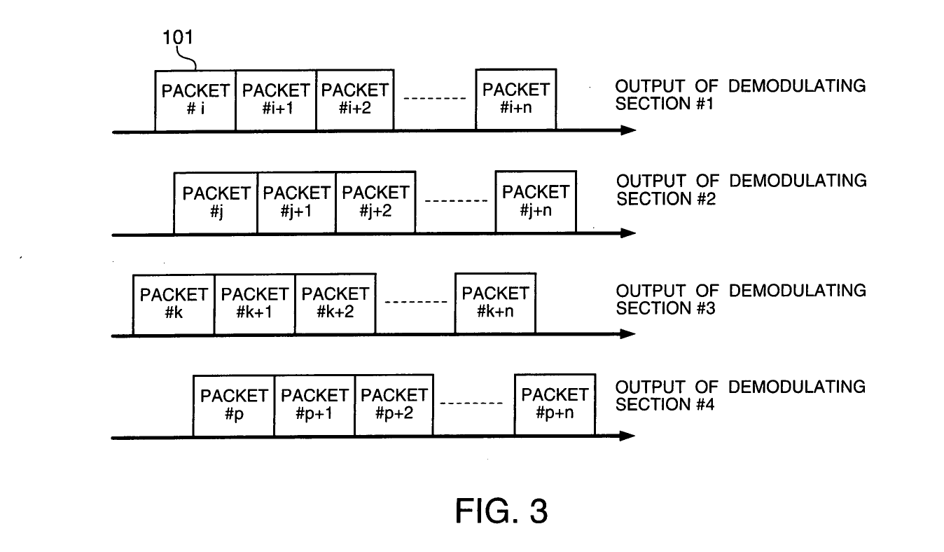

FIG. 3 is an illustration for explaining a plurality of carrying streams output from a plurality of demodulating circuits 2 and input to the program filter 1.

In FIG. 3, a carrying stream output from each demodulating circuit 2 is configured by a plurality of packets 101 arranged on a time base. FIG. 3 shows a mode in which there is no vacant slot between two consecutive packets (continuous). However, it is also permitted to insert a vacant time slot between two consecutive packets.

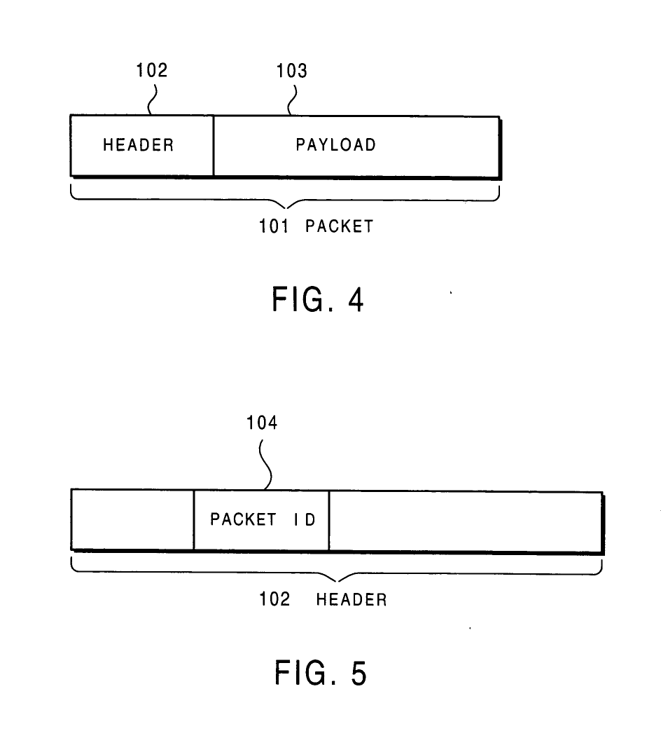

FIG. 4 is an illustration showing a packet format of each packet 101 shown in FIG. 3. In FIG. 4, the packet 101 is configured by a header 102 and a payload 103.

FIG. 5 is an illustration showing a format of the header 102 of the packet shown in FIG. 4. In FIG. 5, the header 102 includes a packet ID 104 showing the type of the information carried by each packet 101.

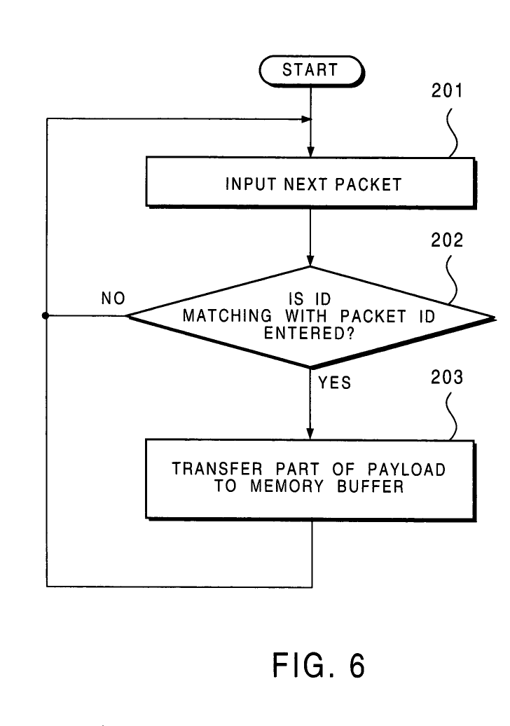

FIG. 6 is a flow chart showing the processing procedure of the packet filter 11 of the first embodiment of the program filter 1 shown in FIG. 2.

Referring to FIG. 6, the packet 101 is input to the packet filter 11 (step 201) to judge whether a packet ID matches the packet ID 104 of the input packet 101 is entered in the packet filter 11 (step 202). In step 202, when a matched packet ID is entered, step 203 is started but when no matched packet ID is entered, step 201 is restarted.

In step 203, the payload portion 103 of the packet 101 is transferred to a memory buffer 3 and step 201 is restarted.

In case of the flow chart shown in FIG. 6, a program filter 1 transfers the payload 103 of the packet 101 to a memory buffer 3. However, it is also permitted to use a configuration for transferring not only the payload 103 but also a part or the whole of a header 102 to the memory buffer 3.

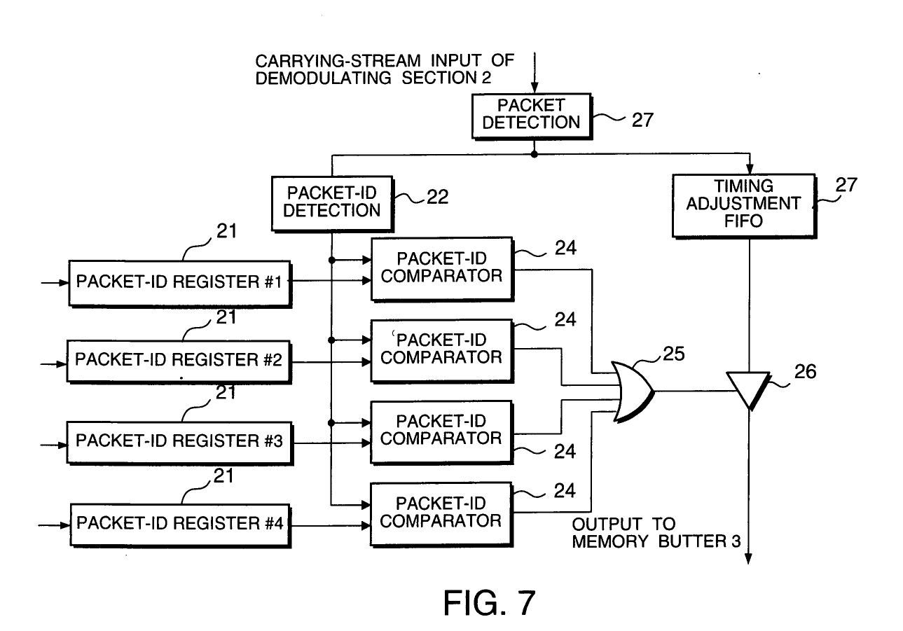

FIG. 7 is an illustration showing the configuration of the packet filter 11 of the program filter 1 of the first embodiment shown in FIG. 2.

In FIG. 7, a carrying stream output from the demodulating circuit 2 is first input to a packet detecting circuit 27 and a packet 101 is separated.

The packet 101 is input to a packet-ID detecting circuit 22 and a timing adjustment FIFO (First In First Out memory) 23.

When the packet 101 is input to the packet-ID detecting circuit 22, the packet ID 104 of the packet 101 (see FIG. 5) is separated and output.

Outputs of the packet-ID detecting circuit 22 and outputs of a plurality of packet ID registers 21 are respectively compared by a packet ID comparator 24 and “1” (positive logic) or “0” (negative logic) is output as a comparison result in accordance with matching or mismatching between the both outputs.

Outputs of a plurality of packet ID comparators 24 are input to an OR circuit 25 and if an output “1” among outputs of the packet ID comparators 24 is output, the OR circuit 25 also outputs When an output of the OR circuit 25 is equal to “1”, an output of a buffer 26 is enabled and an output of the timing adjustment FIFO 23 (packet) is transferred to the memory buffer 3.

For the packet filter 11 shown in FIG. 7, a case is described in which the packet 101 input via the timing adjustment FIFO 23 is directly output to the memory buffer 3. However, it is also permitted to exclude a part of the packet and transfer only the remaining packet to the memory buffer 3.

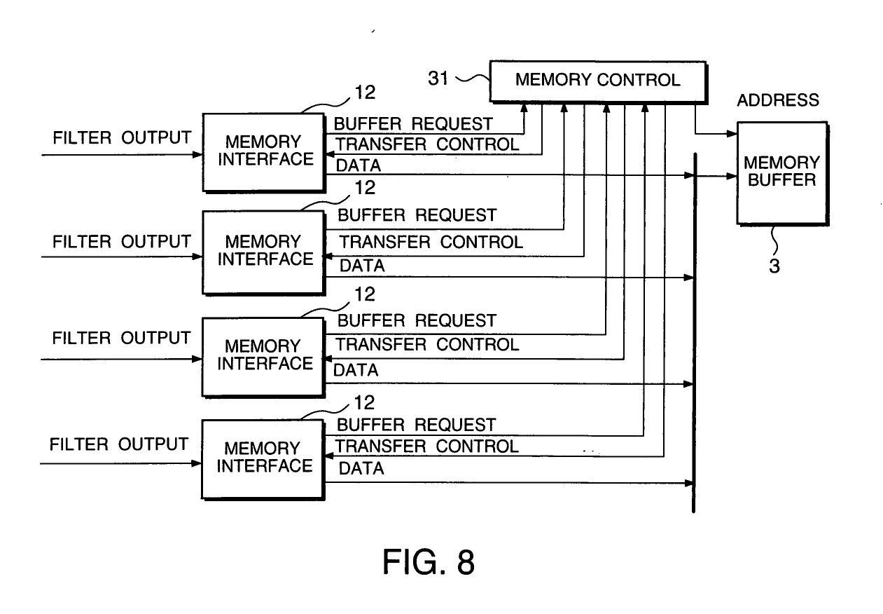

FIG. 8 shows the configuration of the memory interfaces 12 and memory buffer 3 of the program filter 1 shown in FIG. 2 in detail. In FIG. 8, a plurality of memory interfaces 12 respectively issue a buffer request to a memory controlling circuit 31 before outputting data to the memory buffer 3.

The memory controlling circuit 31 adjusts the competition between buffer requests output from a plurality of memory interfaces 12 and performs transfer control for the memory interfaces 12 so that one memory interface 12 at most transfers data to the memory buffer 3.

Moreover, the memory controlling circuit 31 assigns a memory area to each filter output issuing a buffer request in the memory interfaces 12 and outputs an address of an assigned area to the memory buffer 3.

The memory interface 12 output data in accordance with the transfer control by the memory controlling circuit 31 and writes a filter output in the memory buffer 3.

According to the above processing, it is possible to write outputs of a plurality of packet filters 11 in the memory buffer 3 constituted of a single memory space without competition for writing data by controlling assignment of write areas on the memory 3.

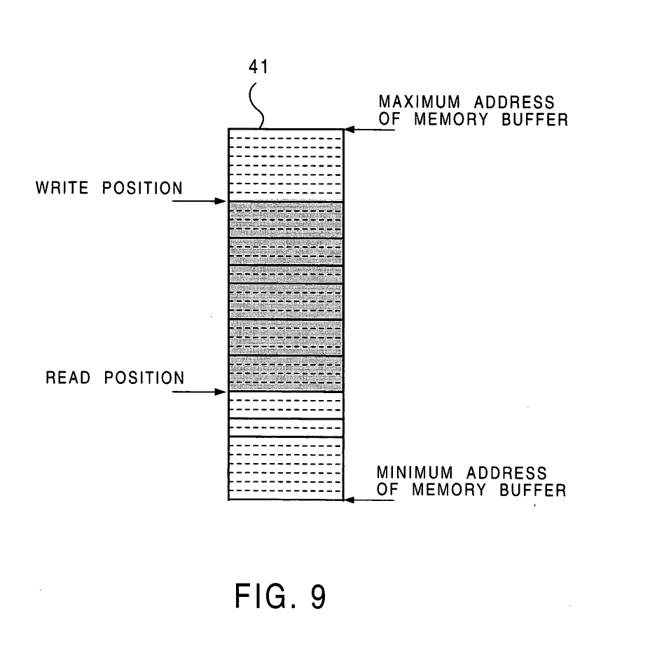

FIG. 9 is an illustration for explaining assignment of areas of filter outputs on the memory buffer 3 in a program filter of the first embodiment. In FIG. 9, a write position and a read position (pointer) are present in an area 41 of the memory buffer 3. Moreover, filter outputs are first written in write positions in order of arrival and the number of write positions is increased in accordance with the length of written data. Furthermore, whenever data is output from the memory buffer 3, the number of read positions is increased in accordance with the length of output data and write and read positions are returned to the memory-buffer minimum address when the positions reach the memory-buffer maximum address. Thus; the memory buffer 3 is configured as a ring-type buffer and every filter output is stored in one memory space.

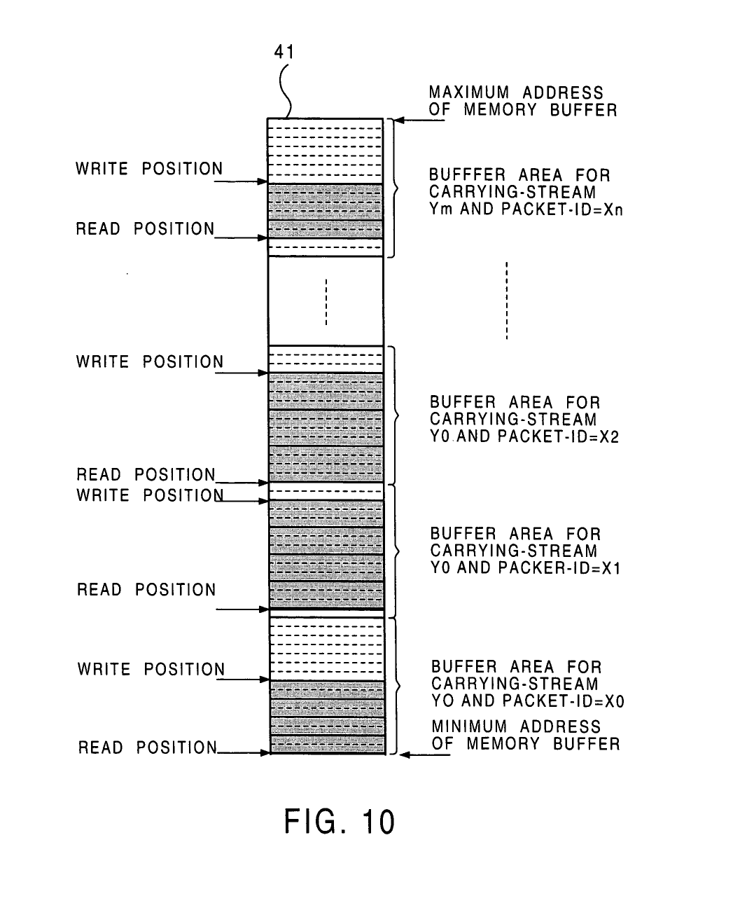

FIG. 10 is an illustration for explaining a method for assigning filter output areas on the memory buffer 3 different from the method in FIG. 9 in the program filter of the first embodiment. In FIG. 10, buffer areas for storing filter outputs are classified for each carrying stream and assigned and each carrying-stream area is assigned to each packet ID. In each classified area, write and read are performed at write position and read position and respectively constituted as a ring-type buffer.

In case of the examples shown in FIGS. 9 and 10, each buffer area is configured as a ring-type buffer. However, it is also permitted to assign a filter-output write position to one fixed area or a plurality of fixed areas instead of handling each buffer area as a ring-type buffer. When a plurality of fixed areas are assigned, to determine a fixed area in which a certain filter output should be written, the following methods are used: a method of assigning fixed areas in order in accordance with a certain algorithm and a method of selecting a fixed area out of every vacant area and assigning it in accordance with a certain rule.

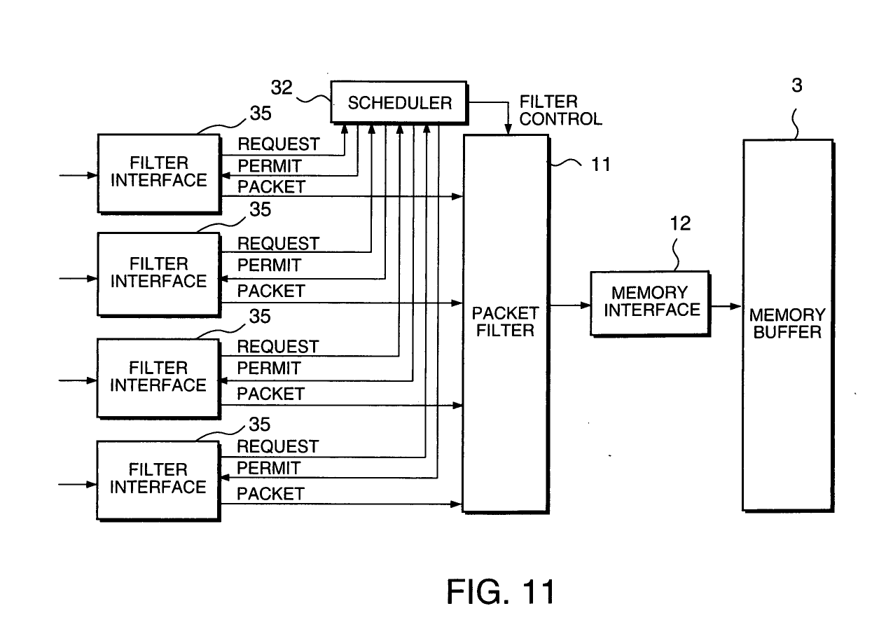

FIG. 11 shows details of a configuration of the program filter 1 and memory buffer 3 shown in FIG. 1 as the second embodiment. In FIG. 11, carrying streams serving as outputs of a plurality of demodulating circuits 2 or each packet configuring the carrying streams is input to filter interfaces 35. Then, when a packet arrives, each filter interface 35 requests a right of use of the filter 11 to a scheduler 32. The scheduler 32 adjusts competitive filter requests and gives a use permit to one filter interface 25.

A filter interface 36 to which the permission is given outputs a packet 101 to a packet filter 11.

The packet filter 11 filter-processes the input packet 101 in accordance with the filter control of the scheduler 32 and transfers a filter processing result to a memory interface 12.

According to the above processing, the packet filter 11 realizes a filter through the time-sharing processing for each packet.

Moreover, the time-sharing processing for storing a packet in a memory buffer 3 is realized by storing the packet in, for example, the memory buffer shown in FIG. 8.

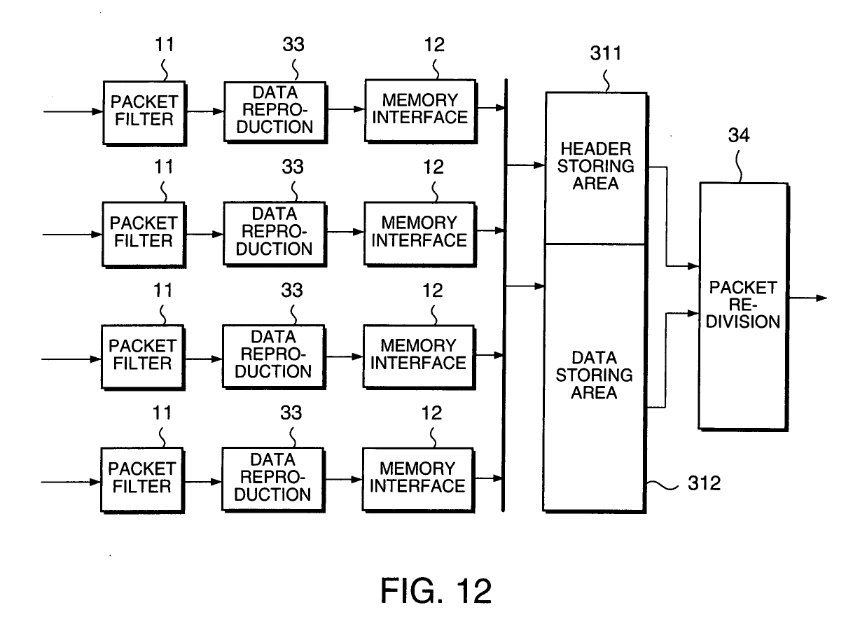

FIG. 12 is an illustration showing a configuration of a program filter 1 configuring a third embodiment. In FIG. 12, outputs of a packet filter 11 are respectively input to a corresponding data reproducing circuit 33. The data reproducing circuit 33 extracts a payload 103 in each packet 101 of a carrying stream to reproduce and recover original data. Moreover, in this case, the circuit 33 extracts a parameter included in a header 102 of each packet 101.

Then, the circuit 33 stores the header 102 or a parameter included in the header 102 in a header storing area 311 via a memory interface 12 and also stores reproduced data in a data storing area 312 via the memory interface 12.

A packet re-dividing circuit 34 divides the data stored in the data storing are 312 into payloads again, re-constitute a header of each packet in accordance with headers and parameters stored in the header storing area 311, combines a generated payload with a header to generate packets, and successively outputs the generated packets.

According to the above processing, only necessary information is extracted from carrying streams output from a plurality of demodulating circuits 2 and carrying-streams are regenerated and output in accordance with extracted data.

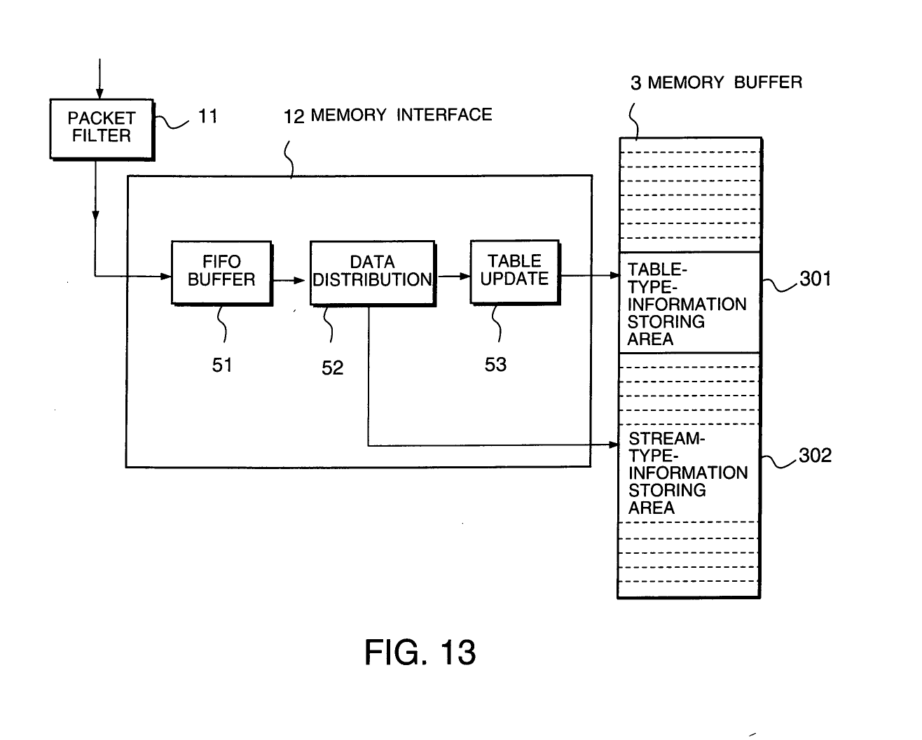

FIG. 13 is an illustration showing a configuration of a program filter 1 configuring a fourth embodiment. Referring to FIG. 13, a memory interface 12 is configured by a FIFO buffer 51, a data distributing circuit 52, and a table updating circuit 53.

The FIFO buffer 51 absorbs a delay due to processings by the data distributing circuit 52 and table updating circuit 53 and a shift of output timing of the packet filter 11.

The data distributing circuit 52 judges whether an output of the packet filter 11 is stream-type information or table-type information. When the circuit 52 judges that the output is the stream-type information, it transfers the output to a stream-type information storing area. When the circuit 52 judges that the output is the table-type information, it transfers the output to the table updating circuit 53.

The table updating circuit 53 successively overwrites input information into a predetermined position of a table-type information storing area. According to the above processing, the table-type information is updated because new information is overwritten on old information whenever new information arrives every a certain time interval.

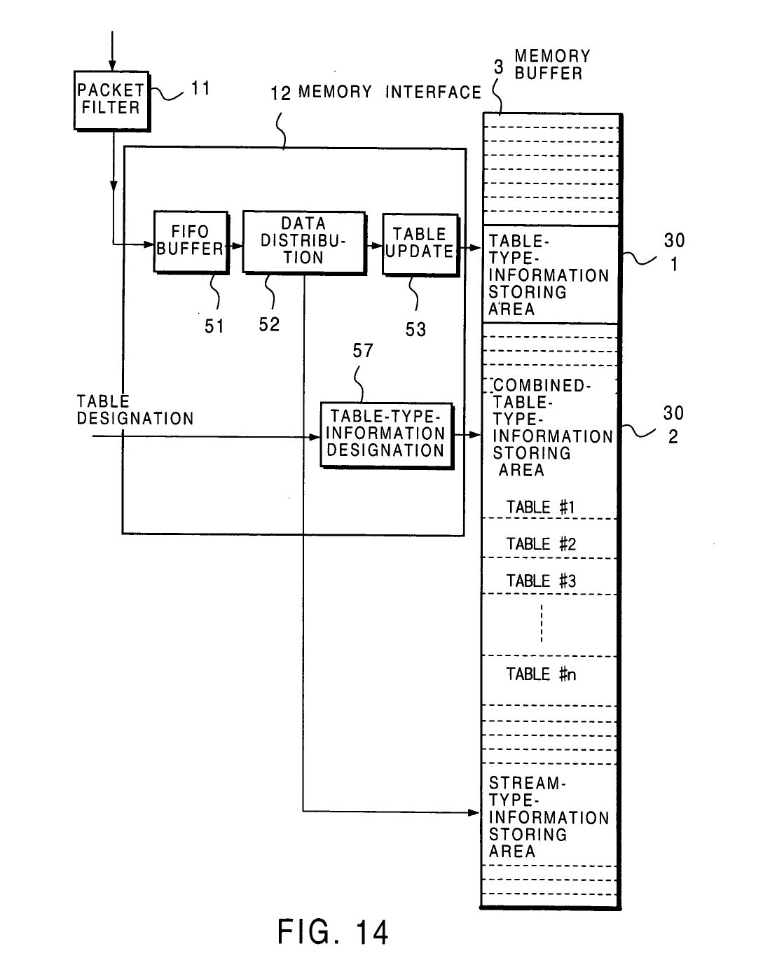

FIG. 14 is an illustration showing a configuration of a program filter 1 configuring a fifth embodiment. Referring to FIG. 14, a memory interface 12 is configured by a FIFO buffer 51, a data distributing circuit 52, a table updating circuit 53, and a table-type-information designating circuit 57. The FIFO buffer 51 absorbs a delay due to processings by the data distributing circuit 52 and table updating circuit 53 and a shift of output timing of a packet filter 11.

The data distributing circuit 52 judges whether an output of the packet filter 11 is stream-type information, table-type information, or combined-table-type information. When the circuit 52 judges that the output is the stream-type information, it transfers an output of the packet filter 11 to the stream-type information storing area. When the circuit 52 judges that the output is the table-type information or combined-table-type information, it transfers the output to the table updating circuit 53.

The table updating circuit 53 transfers input information to a predetermined position of the table-type information storing area when the information is the table-type information and inputs the input information to the table-type-information designating circuit 57 when the information is the combined-table-type information.

The table-type-information designating circuit 57 selects one piece of table-type information or a plurality of pieces of table-type information configuring a plurality of pieces of input combined-table-type information and passes it or them in accordance with a table designation by a user and transfers it or them to a corresponding table of a combined-table-type information storing area 307.

However, in stead of selecting one piece of table-type information or a plurality of pieces of table-type information configuring combined-table-type information before inputting it or them to the memory buffer 3, it is also permitted to temporarily transfer the combined-table-type information to the memory buffer 3 and then select one piece of table-type information or a plurality of pieces of table-type information out of the combined-table-type information when a user accesses the memory buffer 3.

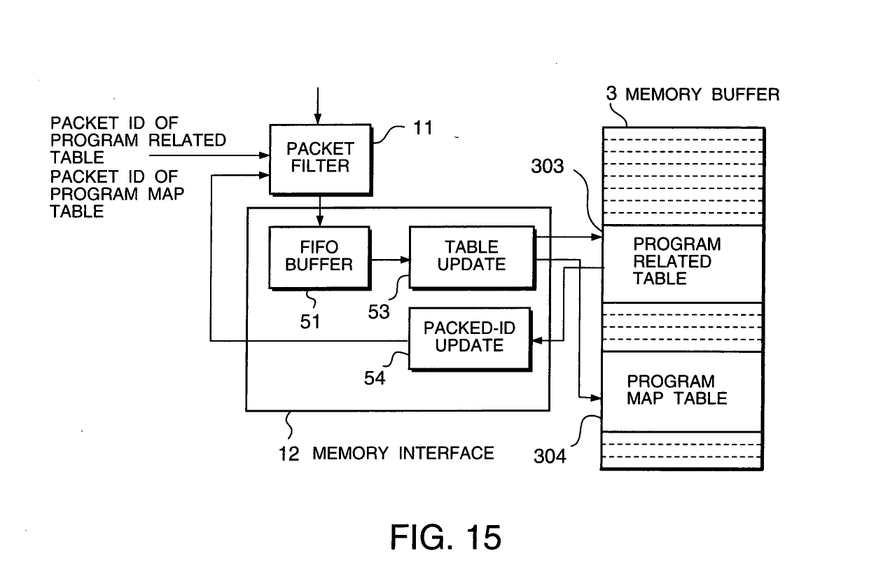

FIG. 15 is an illustration showing a configuration of a program filter 1 configuring a sixth embodiment.

Referring to FIG. 15, a memory interface 12 is provided with a FIFO buffer 51, a table updating circuit 53, and a packet-ID updating circuit 54. The FIFO buffer 51 absorbs a delay due to processing by the table updating circuit 53 and a shift of output timing of a packet filter 11. The table updating circuit 53 updates a program related table 303 and a program map table 304 in accordance with an arriving packet 101.

In this case, information carried by a packet having a predetermined packet ID is stored in the program related table 303. Information related to a packet ID of a packet for carrying the information of the program map table is included in the information carried by the packet.

The program map table 304 stores program information, that is, the information of a packet ID relating to a certain program.

The packet-ID updating circuit 54 reads a packet ID of a packet for carrying the information of the program map table stored in the program related table 303 and sets the packet ID to the packet filter 11. According to the above processing, a program information table constituted of the program related table 303 and program map table 304 is updated.

Incidentally, the program information table having two hierarchies of the program related table 303 and program map table 304 is shown above. However, it is also permitted to form the program information table with a single-hierarchy information table, a program information table configured by three hierarchies or more, or a program information table in which the number of hierarchies depends on the contents of program information or a category.

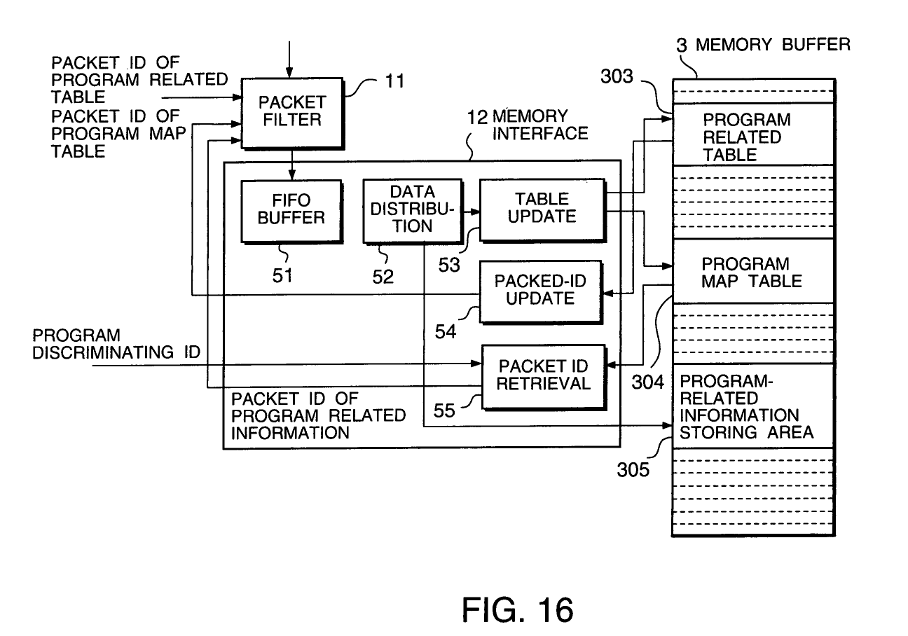

FIG. 16 is an illustration showing a configuration of a program filter 1 configuring a seventh embodiment. Referring to the FIG. 16, the configuration in FIG. 16 is obtained by adding a data distributing circuit 52, a packet-ID retrieving circuit 55, and a program-related-information storing area 305 to the configuration shown in FIG. 15.

Differences between the above-described sixth embodiment and the seventh embodiment will be described below.

A program map table 304 stores a plurality of program discriminating IDs and packet IDs relating to the program discriminating IDs, which is formatted so that a plurality of packet IDs relating to a designated program discriminating ID can be retrieved, when the program discriminating ID is designated.

In case of a packet-ID retrieving circuit 55, a program discriminating ID is input from an external unit to retrieve a packet ID relating to an input program discriminating ID among the packet IDs stored in a program map table 304 and set a packet ID obtained as a result of retrieval to a packet filter 11.

A data distributing circuit 52 transfers the table-type information relating to the program related table 303 and program map table 304 to a table updating circuit 53 and outputs the program related information relating to a designated program discriminating ID to a program-related-information storing area 305.

According to the above configuration, a carrying packet is filtered by using a program information table.

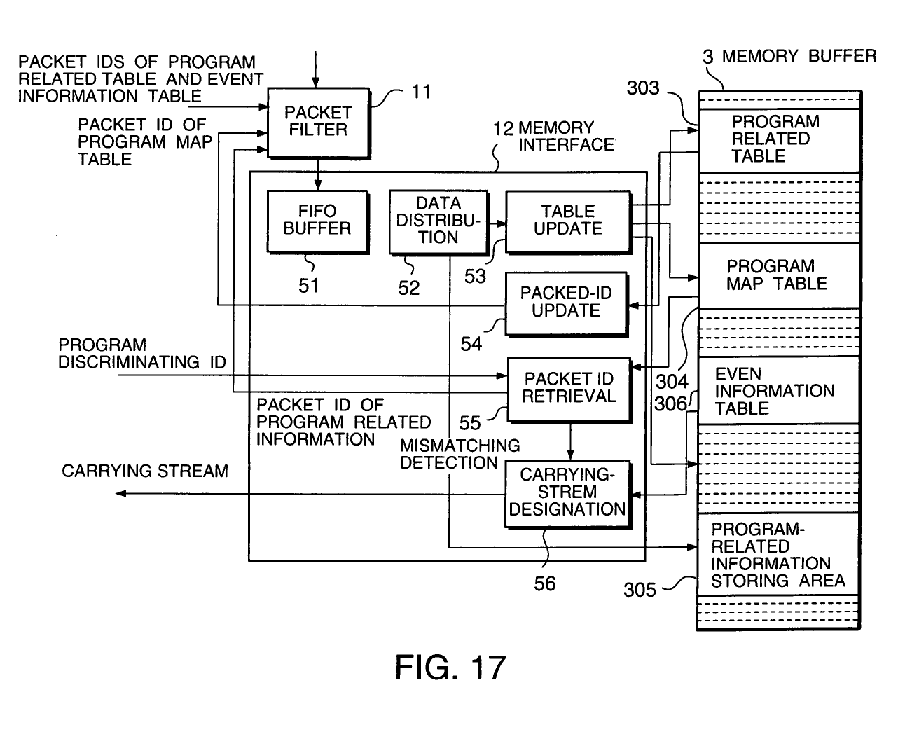

FIG. 17 is an illustration showing a configuration of a program filter 1 configuring the eighth embodiment. Referring to FIG. 17, an output of a packet-ID retrieving circuit 55, a mismatching-program-discriminating-ID carrying-stream designating circuit 56, and an event information table 304 are added compared to the configuration in FIG. 16. Differences between the seventh embodiment shown in FIG. 16 and the eighth embodiments are described below.

Referring to FIG. 17, when a program discriminating ID input to the packet-ID retrieving circuit 55 is not detected by a program map table 302, mismatching detection is output to start the carrying-stream designating circuit 56. When the mismatching detection is input, the carrying-stream designating circuit 56 detects a carrying-stream ID corresponding to a mismatching program discriminating ID from the event information table and outputs the carrying-stream ID to a demodulating circuit 2. Thus, it is possible for the demodulating circuit to set demodulating conditions so as to output the information corresponding to a designated program-discriminating ID. Further, an event information table 306 previously discriminates a packet ID of a packet for carrying the information and the packet ID is set to the packet filter 11. Moreover, a value of the event information table 306 is updated by table update 53. Furthermore, a carrying-stream ID is an identifier for distinguishing one carrying stream from other carrying streams sent from a broadcasting station. By designating a carrying-stream ID to the demodulating circuit 2, a carrying stream designated by the carrying-stream ID is output.

Incidentally, in case of the above embodiment, it is assumed that the packet ID of the packet for carrying the information of the event information table 306 is previously discriminated. However, it is clear that the same effect can be also obtained by designating a packet ID via a hierarchical program information table by using a program map table or other table-type information.

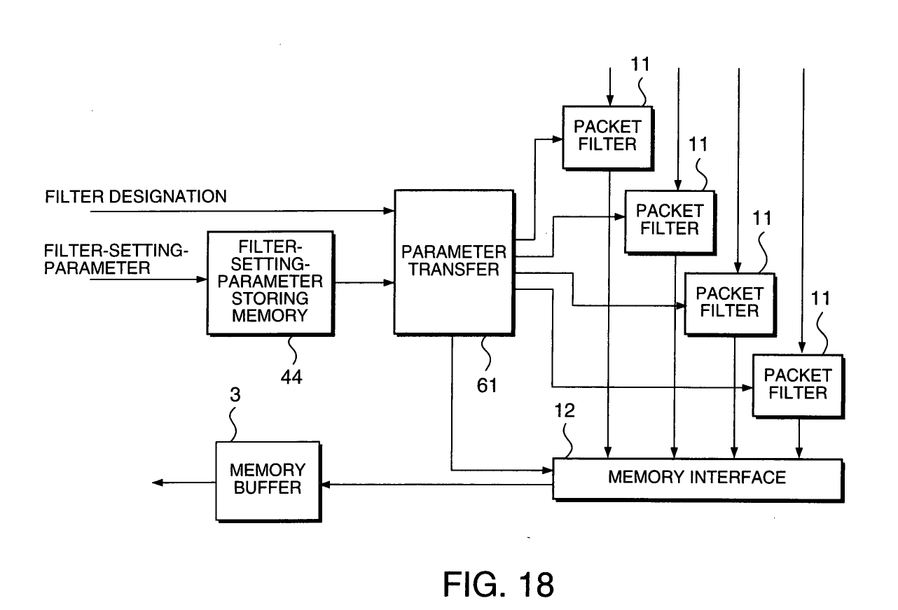

FIG. 18 is an illustration showing a configuration of a program filter 1 configuring the ninth embodiment. Referring to FIG. 18, filter setting parameters corresponding to a plurality of packet filters present in the program filter 1 are set to a filter-setting-parameter storing memory 44 from an external unit.

A parameter transferring circuit 61 sets the parameters stored in the filter-setting-parameter storing memory 44 to their corresponding packet filters 11 in accordance with the filter designation input from an external unit. In this case, the filter designation includes the information showing which parameter should be applied to a packet filter 11 among the parameters set to the filter-setting-parameter storing memory 44 and the information showing to a packet filter 11 to which the parameter should be applied among a plurality of packet filters 11 in case of application. Moreover, when a packet filter 11 to which the parameter is set is designated, the parameter is set to the packet filter 11. Alternatively, the same effect can be obtained by retrieving packet filters 11 to which a designated parameter can be set and setting the parameter to one of the packet filters 11. Each packet filter 11 selects and passes a packet input in accordance with a set parameter and transfers the packet to a memory interface 12. The memory interface 12 stores the packet in a storing area on a memory buffer 3 corresponding to the type of the input packet.

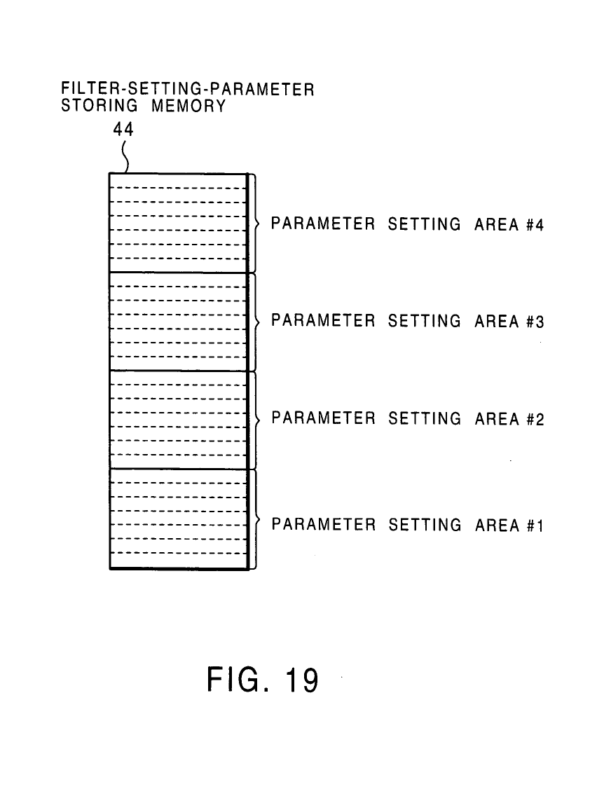

FIG. 19 is an illustration showing an example of memory assignment of the filter-setting-parameter storing memory 44 in FIG. 18. Referring to FIG. 19, the filter-setting-parameter storing memory 44 is divided into a plurality of parameter setting areas and a parameter used to set the packet filter 11 is stored in each parameter setting area.

According to the present invention, the following advantages can be obtained.

A first advantage of the present invention is that a plurality of carrying streams can be filter-processed in parallel at the same time. This is because the present invention is provided with a packet filter for receiving inputs from a plurality of demodulating circuits and extracting only necessary information according to a designation of a user out of the received inputs, in which the packet filter judges whether a packet ID of each packet matches a previously entered packet ID, passes the packet when the packet matches the previously entered packet, and writes the passed packet in a memory buffer.

A second advantage of the present invention is that it is unnecessary to interrupt another processing of a user program by outputting a filtered result to a request from a user.

A third advantage of the present invention is that it is possible to improve the memory efficiency and reduce the memory capacity.

A fourth advantage of the present invention is that an access to a single memory space is made possible at the time of writing or reading a filtered result.

A fifth advantage of the present invention is that it is made possible to execute filtering with a single processor.

A sixth advantage of the present invention is that a result of filtering a plurality of carrying streams can be output as carrying streams by packet-dividing the result.

A seventh advantage of the present invention is that it is possible to reduce the memory capacity required to store table-type information.

An eighth advantage of the present invention is that it is possible to reduce the memory capacity required to store combined-table-type information.

A ninth advantage of the present invention is that it is possible to improve the convenience of outside users by outputting pieces of table-type information configuring combined-table-type information separately from each other.

A tenth advantage of the present invention is that a program information table based on the latest information is always realized by automatically updating the table.

An eleventh advantage of the present invention is that it is possible to filter a carrying packet by designating a program discriminating ID instead of designating a packet ID directly from an external unit.

A twelfth advantage of the present invention is that it is possible to judge in a program filter whether the information requested by a user can be obtained from a carrying stream.

A thirteenth advantage of the present invention is that, when it is judged that the information requested by a user cannot be obtained from a carrying stream, it is possible that a program filter automatically changes settings of a demodulating circuit to make the demodulating circuit output a necessary carrying stream.

A fourteenth advantage of the present invention is that it is possible to apply a certain filtering condition to an optional carrying stream by making it possible to set filtering conditions independently of carrying streams.

A fifteenth advantage of the present invention is that it is possible to apply a filtering condition once set to a carrying-stream output of a demodulating circuit not used at that point of time and reduce the throughput for setting filtering conditions.

1. A program filter using a plurality of carrying streams output from a plurality of demodulating circuits as inputs to filter the carrying streams, divide the data obtained as a result of filtering the streams into packets again, and output the packets as carrying streams, comprising:
a storing circuit for temporarily storing a header of a packet among packets configuring an input carrying stream or a parameter included in the header when filtering the carrying streams; and
a packet re-dividing circuit for dividing the data obtained as a result of filtering into a plurality of packets again and thereafter generating a carrying stream in which the divided packets are combined with the header of a header re-constituted in accordance with the parameter.

2. A program filter using a plurality of carrying streams output from a plurality of demodulating circuits as inputs to filter the carrying streams and output filtered results; wherein:
table-type information which is the information repeatedly transferred every a certain time interval and stream-type information which is the information whose contents change every moment are distinguished in order to update the information having a predetermined format from the information input as the carrying streams, and when the information which newly arrives is the table-type information, the information is overwritten on the information stored in a storing circuit and when the information which newly arrives is the stream-type information, the information is stored in a storing area different from the information already stored in the storing circuit.

3. A program filter using a plurality of carrying streams output from a plurality of demodulating circuits to filter the carrying streams and output filtered results, wherein:
a program information table, a parameter setting circuit for setting a parameter of a packet to be filtered in accordance with the information stored in the program information table, and an updating circuit for filtering a packet input in accordance with the set parameter, referring the packet passing through the filter, and updating the program information table are included.

4. The program filter as claimed in claim 3, wherein:
a designated program-discriminating ID is converted into a corresponding packet ID by referring to the program information table to filter a carrying packet by using the packet ID obtained as a result of conversion.

5. The program filter as claimed in claim 3, wherein:
when it is judged that as a result of referring to the program information table, the information requested by a user cannot be obtained from the carrying streams which are outputs of the demodulating circuit, settings of the demodulating circuit are changed so as to output a carrying stream required by the demodulating circuit by referring to the program information table.

6. A program filter inputting a plurality of carrying streams output from a plurality of demodulating circuits to filter the carrying streams and outputting filtered results, making it possible to independently set a filtering condition for a certain carrying stream and a carrying stream to which the filtering condition should be applied independent of the filtering condition.

7. A digital-broadcast receiving apparatus comprising:
a plurality of demodulating circuits,
a program filter for inputting a plurality of carrying streams output from the demodulating circuits, filtering the carrying streams, and outputting filtered results,
a memory buffer for storing outputs of the program filter,
a recording/reproducing circuit or a decoder,
a date reproducing circuit, and
a packet re-dividing circuit, wherein
the program filter is provided with a packet filter for receiving inputs from the demodulating circuit and extracting only necessary information according to a designation of a user out of the inputs and a memory interface circuit for writing outputs of the packet filter in the memory buffer,
the packet filter is provided with a judging circuit for comparing and judging whether a packet ID of each packet of a carrying stream output from the demodulating circuit matches a previously entered packet ID and a controlling circuit for passing the packet whose packet ID matches the previously entered packet ID as a result of comparison,
the memory interface circuit writes a packet output from the packet filter in the memory buffer,
the data reproducing circuit corresponds to each of the packet filters and using outputs of the packet filters as inputs to reproduce original data in accordance with a payload in each packet of the carrying stream, store a header of each packet and a parameter in the header into a header storing circuit of the memory buffer, and store the original data in a data storing circuit of the memory buffer, and
the packet re-dividing circuit divides the data stored in the data storing circuit into payloads again and, reconfigures a header of each packet in accordance with the header and parameter stored in the header storing circuit, combines generated payloads with the header to generate packets, and successively outputs generated packets.

8. A digital-broadcast receiving apparatus comprising:
a plurality of demodulating circuits,
a program filter for inputting a plurality of carrying streams output from the demodulating circuits, filtering the carrying streams, and outputting filtered results,
a memory buffer for storing outputs of the program filter,
a recording/reproducing circuit or a decoder, wherein
the program filter is provided with a packet filter for receiving inputs from the demodulating circuit and extracting only necessary information according to a designation of a user out of the inputs and a memory interface circuit for writing outputs of the packet filter in the memory buffer,
the packet filter is provided with a judging circuit for comparing and judging whether a packet ID of each packet of a carrying stream output from the demodulating circuit matches a previously entered packet ID and a controlling circuit for passing the packet whose packet ID matches the previously entered packet ID as a result of comparison,
the memory interface circuit writes a packet output from the packet filter in the memory buffer, and wherein the memory interface circuit is provided with:
a FIFO-type buffer for absorbing delays due to the processings by the data distributing circuit and the table updating circuit and shifts of output timings of the packet filters,
a data distributing circuit for judging whether outputs of the packet filters are stream-type information or table-type information and, when the outputs are judged to be the stream-type information, transferring the outputs to a stream-type information storing circuit of the memory buffer and when they are judged to be the table-type information, transferring them to the table updating circuit, and
a table updating circuit for successively overwriting input pieces of information at predetermined positions of a table-type-information storing circuit.

9. A digital-broadcast receiving apparatus comprising:
a plurality of demodulating circuits,
a program filter for inputting a plurality of carrying streams output from the demodulating circuits, filtering the carrying streams, and outputting filtered results,
a memory buffer for storing outputs of the program filter, and
a recording/reproducing circuit or a decoder, wherein
the program filter is provided with a packet filter for receiving inputs from the demodulating circuit and extracting only necessary information according to a designation of a user out of the inputs and a memory interface circuit for writing outputs of the packet filter in the memory buffer,
the packet filter is provided with a judging circuit for comparing and judging whether a packet ID of each packet of a carrying stream output from the demodulating circuit matches a previously entered packet ID and a controlling circuit for passing the packet whose packet ID matches the previously entered packet ID as a result of comparison,
the memory interface circuit writes a packet output from the packet filter in the memory buffer, and wherein the memory interface circuit is provided with:
a FIFO buffer for absorbing delays due to processings by the data distributing circuit and the table updating circuit and shifts of output timings of the packet filters,
a data distributing circuit for judging whether outputs of the packet filters are stream-type information, table-type information, or combined-table-type information, and when the outputs of the packet filters are judged to be the stream-type information, transferring the outputs of the packet filters to a stream-type-information storing area in the memory buffer and when they are judged to be the table-type information or combined-table-type information, transferring them to a table updating circuit, and
a table updating circuit for, when input information is the table-type information, transferring it to a table-type-information storing circuit in the buffer memory and when the input information is the combined-table-type information, transferring it to a table-type-information designating circuit, and
the table-type-information designating circuit selects table-type information out of input combined-table-type information in accordance with a table designation by a user to pass the table-type information and transfers the table-type information to a combined-table-type-information storing circuit in the memory buffer.

10. A digital-broadcast receiving apparatus comprising:
a plurality of demodulating circuits,
a program filter for inputting a plurality of carrying streams output from the demodulating circuits, filtering the carrying streams, and outputting filtered results,
a memory buffer for storing outputs of the program filter, and
a recording/reproducing circuit or a decoder, wherein
the program filter is provided with a packet filter for receiving inputs from the demodulating circuit and extracting only necessary information according to a designation of a user out of the inputs and a memory interface circuit for writing outputs of the packet filter in the memory buffer,
the packet filter is provided with a judging circuit for comparing and judging whether a packet ID of each packet of a carrying stream output from the demodulating circuit matches a previously entered packet ID and a controlling circuit for passing the packet whose packet ID matches the previously entered packet ID as a result of comparison,
the memory interface circuit writes a packet output from the packet filter in the memory buffer, and wherein the memory interface circuit is provided with:
a FIFO buffer for absorbing delays due to processings by the table updating circuit and packet-ID updating circuit and shifts of output timings of the packet filters,
a table updating circuit for updating a program related table for storing the information transferred by a packet provided with a predetermined packet ID in accordance with a packet which arrives and a program map table for storing a packet ID relating to a program, and
a packet-ID updating circuit for reading packet IDs of packets for carrying the information of the program map table stored in the program related table, setting the packet IDs to the packet filters, and updating a program information table constituted of the program related table and the program map table.

11. The digital-broadcast receiving apparatus as claimed in claim 10, wherein:
a program map table formatted so that a plurality of program discriminating IDs and packet IDs relating to the program discriminating IDs are stored and when designating a certain program discriminating ID, a plurality of packet IDs relating to the program discriminating ID can be retrieved, and a packet-ID retrieving circuit to which a program discriminating ID is input from an external unit to retrieve a packet ID relating to an input program-discriminating ID among packet IDs stored in the program map table and supply a packet ID obtained as a result of retrieval to a packet filter are included, and
the data distributing circuit transfers table-type information relating to the program related table and the program map table to the table updating circuit and outputs program related information relating to a designated program-discriminating ID to a program-related-information storing circuit.

12. The digital-broadcast receiving apparatus as claimed in claim 11, wherein:
the packet-ID retrieving circuit outputs mismatching detection when an input program discriminating ID is not detected in a program map table, starts a carrying-stream designating circuit,
the carrying-stream designating circuit extracts a carrying-stream ID corresponding to a mismatching-program discriminating ID from an event information table when mismatching detection is input and outputs the carrying-stream ID to the demodulating circuit, and
the demodulating circuit outputs a carrying stream having the carrying-stream ID.

13. The digital-broadcast receiving apparatus as claimed in claim 11, wherein:
a storing circuit for storing and holding a filter setting parameter for each of the packet filters and the filter setting parameters of the packet filters are made changeable.

14. A digital-broadcast receiving method using a plurality of carrying streams output from a plurality of demodulating circuits as inputs to filter the carrying streams, divide the data obtained as a result of filtering into packets again, and output the packets as carrying streams, the method comprising the steps of:
temporarily storing in the storing circuit a header of each packet passing through a filter or a parameter included in the header among packets configuring an input carrying stream when filtering the carrying streams; and
dividing the data obtained as a result of filtering into a plurality of packets again to generate a carrying stream in which the divided packets are combined with the header reconstituted in accordance with the parameter.

15. A digital-broadcast receiving method using a plurality of carrying streams output from a plurality of demodulating circuits as inputs to filter the carrying streams and output filtered results, the method comprising the steps of:
distinguishing between table-type information which is the information repeatedly transferred at a certain time interval and stream-type information which is the information whose contents change every moment in order to update the information having a predetermined format in accordance with the information input as the carrying stream; and
overwriting the information which newly arrives on the information stored in a storing circuit when the former information is the table-type information and storing the information which newly arrives in a storing area different from the information already stored in the storing circuit when the former information is the stream-type information.

16. A digital-broadcast receiving method using a plurality of carrying streams output from a plurality of demodulating circuits as inputs to filter the carrying streams and output filtered results, the method comprising the steps of:
setting a parameter of a packet to be filtered in accordance with the information stored in a program information table;
filtering an input packet in accordance with the set parameter; and
referring to a packet passing through the filter and updating the program information table.

17. The digital-broadcast receiving method as claimed in claim 16, wherein:
a designated program-discriminating ID is converted into a corresponding packet ID by referring to the program information table and a carrying packet is filtered by using the packet ID obtained as a result of conversion.

18. The digital-broadcast receiving method as claimed in claim 16, wherein:
when it is judged that the information requested by a user cannot be obtained from the carrying streams which are outputs of the demodulating circuits as a result of referring to the program information table, settings of the demodulating circuits are changed so as to output carrying streams required by the demodulating circuits by referring to the program information table.

19. A digital-broadcast receiving method using a plurality of carrying streams output from a plurality of demodulating circuits as inputs to filter the carrying streams and output filtered results, making it possible to set a filtering condition corresponding to a certain carrying stream and a carrying stream to which the filtering condition should be applied independent of said filtering condition.

20. A bitstream using a plurality of carrying streams output from a plurality of demodulating circuits as inputs to filter the carrying streams and represent a result of dividing the data obtained as a result of filtering into packets again, the bitstream produced by the steps of:
temporarily storing a header of each packet passing through a filter among packets configuring an input carrying stream or a parameter included in the header when filtering the carrying streams; and
dividing the data obtained as a result of filtering into a plurality of packets again and thereafter, generating a carrying stream in which the divided packets are combined with the header or a header reconstituted in accordance with the parameter.

21. A bitstream using a plurality of carrying streams output from a plurality of demodulating circuits as inputs to filter the carrying streams and represent a result of filtering, the bitstream produced by the steps of:
distinguishing between table-type information which is the information repeatedly transferred at a certain time interval and stream-type information which is the information whose contents change every moment in order to update the information having a predetermined format in accordance with the information input as the carrying stream; and
overwriting the information which newly arrives on the information stored in a storing circuit when the former information is the table-type information and storing the information which newly arrives in a storing area different from the information already stored in the storing circuit when the former information is the stream-type information.

22. A bitstream using a plurality of carrying streams output from a plurality of demodulating circuits as inputs to filter the carrying streams and represent a result of filtering, the bitstream produced by the steps of:
setting a parameter of a packet to be filtered in accordance with the information stored in a program information table;
filtering an input packet in accordance with the set parameter; and
referring to a packet passing through the filter and updating the program information table.

23. The bitstream as claimed in claim 22, wherein:
a designated program-discriminating ID is converted into a corresponding packet ID by referring to the program information table and a carrying packet is filtered by using the packet ID obtained as a result of conversion.

24. The bitstream as claimed in claim 22, wherein:
when it is judged that the information requested by a user cannot be obtained from the carrying streams which are outputs of the demodulating circuits as a result of referring to the program information table, settings of the demodulating circuits are changed so as to output carrying streams required by the demodulating circuits by referring to the program information table.

25. A bitstream using a plurality of carrying streams output from a plurality of demodulating circuits as inputs to filter the carrying streams and show a result of filtering, making it possible to set a filtering condition for a certain carrying stream and a carrying stream to which the filtering condition should be applied independent of the filtering condition.
